(19) United States
(12) Patent Application Publication
(10) Pub. No.: US 2025/0156308 A1
(43) Pub. Date: May 15, 2025

(54) MEMORY DEVICE AND MANAGING METHOD THEREOF

(71) Applicant: MEDIATEK INC., Hsinchu City (TW)

(72) Inventors: Hsien-Peng Wang, Hsinchu City (TW); Wei-Ting Hung, Hsinchu City (TW); Yi-Yen Hsieh, Hsinchu City (TW)

(21) Appl. No.: 18/826,561

(22) Filed: Sep. 6, 2024

Related U.S. Application Data
(60) Provisional application No. 63/598,136, filed on Nov. 12, 2023.

(51) Int. Cl. G06F 12/02

(52) U.S. Cl. CPC G06F 12/0223

(57) ABSTRACT

A memory device, for cooperating with at least one computing engine to perform several neural network computations, comprises the following elements. A memory storage, used to store data for the at least one computing engine. A memory controller, used to utilize several registers to manage several memory spaces in the memory storage, and execute a first instruction to control at least two data paths in the neural network computations. The first instruction is utilized to duplicate a first register to a second register of the registers, to allow the first register and the second register share one of the memory spaces in the memory storage.

This application claims the benefit of U.S. provisional application Ser. No. 63/598,136, filed Nov. 12, 2023, the disclosure of which is incorporated by reference herein in its entirety.

### TECHNICAL FIELD

The disclosure relates to a memory device, and particularly relates to a memory device for neural network computations and a managing method thereof.

### BACKGROUND

The artificial intelligence (AI) technology often utilizes neural network (NN) models to perform computations for deep learning. In the computations through multiple layers of the NN models, skip connections can be employed so as to bypass certain layers and hence directly add inputs or intermediate activations outputs of some deeper layers. Furthermore, split connections are frequently utilized so as to enable the network of NN models to retain or propagate inputs or intermediate activations. In the split connections, the interested data of a previous layer of NN models are copied to form multiple data paths, and these copied data may be stored in an L1 (Level 1) memory of the computing system.

If only one copy of the interested data is kept in the L1 memory, the split connections may be difficult to control since competition for this single copy will be caused. To address this competition issue, the interested data may be duplicated as multiple copies in the L1 memory, but unfortunately it may cause a great occupation of the L1 memory.

To resolve the above issue in the split connections, it is desirable to have an improved architecture of memory device and an improved managing method for the memory device. With the improved memory device and managing method, only one copy of the interested data is needed, which can greatly save occupied space in a memory storage (e.g., the L1 memory).

### SUMMARY

According to one embodiment of the present disclosure, a memory device is provided. The memory device is for cooperating with at least one computing engine to perform several computations. The memory device comprises the following elements. A memory storage, used to store data for the at least one computing engine. A memory controller, used to utilize several registers to manage several memory spaces in the memory storage, and execute a first instruction to control at least two data paths in the computations. The first instruction is utilized to duplicate a first register to a second register of the registers, to allow the first register and the second register share one of the memory spaces in the memory storage.

According to another embodiment of the present disclosure, a managing method for a memory device is provided. The memory device cooperates with at least one computing engine to perform several computations. The managing method comprises the following steps. Data are stored for the at least one computing engine, by a memory storage of the memory device. Several registers are utilized to manage several memory spaces in the memory storage, by a memory controller of the memory device. A first instruction is executed to control at least two data paths in the computations, by the memory controller. The first instruction is utilized to duplicate a first register to a second register of the registers, to allow the first register and the second register share one of the memory spaces in the memory storage.

### BRIEF DESCRIPTION OF THE DRAWINGS

FIG. 1 illustrates a block diagram illustrating a memory device and computing engines, according to an embodiment of the present disclosure.

FIG. 2 illustrates a block diagram of the memory controller according to an embodiment of the present disclosure.

FIG. 3 illustrates a schematic diagram showing split data paths of split connections in a neural network model.

FIG. 4A which illustrates a schematic diagram showing memory allocation of a memory storage.

FIG. 4B, which illustrates another schematic diagram showing memory allocation of the memory storage.

FIG. 5 illustrates a schematic diagram showing a comparative example of split data paths of split connections in the neural network model.

FIG. 6A illustrates a schematic diagram showing memory allocation of the registers in the memory storage.

FIG. 6B illustrates another schematic diagram showing memory allocation of the registers in the memory storage.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

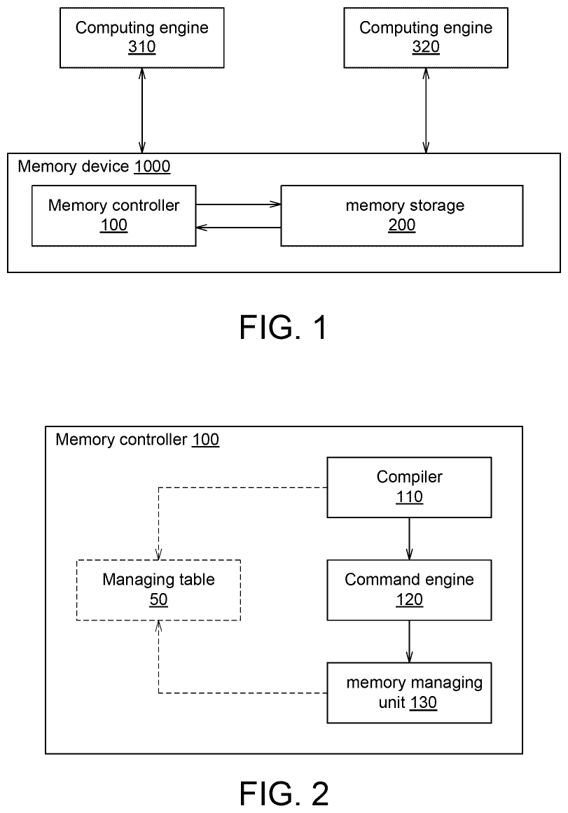

FIG. 1 illustrates a block diagram illustrating a memory device 1000 and computing engines 310 and 320, according to an embodiment of the present disclosure. Referring to FIG. 1, the computing engines 310 and 320 cooperate with the memory device 1000 to perform computations, such as vector computations, matrix computations, and three-dimensional (3D) computations, etc. The computing engines 310 and 320 serve as processing cores which are used to execute the above computations. Furthermore, the memory device 1000 is used to store data related to these computations. Such as, the computing engines 310 and 320 may produce data and write the produced data to the memory device 1000, on the other hand, the computing engines 310 and 320 may consume data and read the consumed data from the memory device 1000.

The memory device 1000 includes a memory controller 100 and a memory storage 200. The memory storage 200 may be any type of volatile storage or non-volatile storage, e.g., a dynamic random access memory (DRAM), a static random access memory (DRAM), a flash memory or a cache memory, etc. Furthermore, the memory storage 200 may be a mass storage medium, e.g., an optical disc, a hard disc drive (HDD) or a solid state drive (SSD), etc. More particularly, in operation, the memory storage 200 provides a unified memory space (i.e., a “common pool”) utilizing a “shared memory” mechanism to store data for the computing engines 310 and 320. The memory controller 100 is used to control read operations and write operations for the computing engines 310 and 320 and the memory storage 200. In addition, the memory controller 100 may manage data movements, data allocation and data deallocation for the computing engines 310 and 320 and the memory storage 200.

FIG. 2 illustrates a block diagram of the memory controller 100 according to an embodiment of the present disclosure. Referring to FIG. 2, the memory controller 100 includes a compiler 110, a command engine 120 and a memory managing unit 130. The memory controller 100 may utilize a plurality of registers (e.g., N registers r1 to rn) to manage memory spaces in the memory storage 200 for write operations and read operations, wherein N is a positive integer. Each of the registers r1 to rn has an identifier referred to as “Rid”. The register r1 has an identifier Rid of “1”, and the register r2 has an identifier Rid of “2”, etc.

The memory controller 100 utilizes a managing table 50 to manage the registers r1 to rn. The compiler 110 may be executed in the memory controller 100 to generate a set of assembly codes, and thus generate the managing table 50 based on the identifier Rid of the registers r1 to rn. Table 1 shows an example of the contents of the managing table 50. As shown in Table 1, each of the registers r1 to rn may have a plurality of parameters and indicators. In the first column of the managing table 50, the identifiers Rid of “1” to “N” are recorded. In other columns of the managing table 50, parameters of “base address”, “bound address”, “delete size”, “head pointer”, “tail pointer” and “DUP Rid” and two indicators named “SEND busy” and “RECV busy” are recorded. The “DUP Rid” may be referred to as a “duplication identifier”.

TABLE 1

| | base | bound | delete | head | tail | SEND | RECV | DUP |
|---|---|---|---|---|---|---|---|---|
| Rid | address | address | size | pointer | pointer | busy | busy | Rid |
| 1 | 0x00 | 0x10 | | 0x00 | 0x10 | 1 | | |
| 2 | | | | | | | | |
| 3 | 0x10 | 0x20 | | 0x10 | 0x20 | 1 | | |
| 4 | | | | | | | | |
| 5 | 0x20 | 0x40 | | 0x20 | 0x30 | | 1 | |
| . . . | | | | | | | | |
| N | | | | | | | | |

The base address and bound address are used to handle memory space allocation for the memory storage 200, such as, defining a reserved memory space in the memory storage 200 for the corresponding register. Taking the register r1 (with the identifier Rid of “1” in the managing table 50) as an example, the base address of the register r1 is “0x00”, and its bound address is “0x10”, hence a reserved memory space of 16 bytes in the memory storage 200 is defined for the register r1. Furthermore, the delete size is used to indicate the amount of data which can be released from a corresponding register after last read operation or last write operation, the delete operation will move the head pointer of a register without really clearing data in the memory spaces. The base address, bound address and delete size are provided and maintained by the compiler 110 in a software level.

The indicator “SEND busy” is used to indicate a busy state for a read operation for a corresponding register, which indicates that a read operation for this interested register is under performing. On the other hand, the indicator “RECV busy” is used to indicate a busy state for a write operation for a corresponding register, which indicates that a write operation for this interested register is under performing.

The head pointer and tail pointer are used to respectively indicate a start and an end of stored data for the corresponding register, and the stored data may be referred to as “available data” in this register. The available data defined by the head pointer and tail pointer should fall within the reserved memory space defined by the base address and the bound address. In other words, the head pointer and tail pointer should be located between the base address and bound address. The head pointer, tail pointer and indicators “SEND busy” and “RECV busy” are handled by the memory managing unit 130. The memory managing unit 130 may be a hardware element (e.g., a lumped circuit, a micro-processor, or an ASIC chip) embedded in the memory controller 100. That is, when performing read operations and write operations, the head pointer, tail pointer and indicators “SEND busy” and “RECV busy” are controlled by the memory managing unit 130 in a hardware level, which needs not be handled by the compiler 110 in the software level.

Furthermore, the command engine 120 may serve as an interface between the compiler 110 and the memory managing unit 130. In operation, the command engine 120 is responsible for sending related hardware commands to the memory managing unit 130.

The compiler 110 provides an instruction named “Register_rid”, which is used to set required information for a corresponding one of the registers r1 to rn. The required information at least includes the base address, bound address and delete size in the managing table 50. Furthermore, the compiler 110 provides another instruction named “Duplicate” which is used to handle data control for split data paths (i.e., split flows) of split connections. Referring to Table 2-1, which shows the contents and parameters of the “Duplicate” instruction. The “Duplicate” instruction has an opcode (i.e., operational code) of “DUP” and two data fields of “Dest_Rid” (i.e., destination Rid) and “Src_Rid” (i.e., source Rid). The Src_Rid identifies a register which is a source of duplication, i.e., a source to be duplicated. On the other hand, the Dest_Rid identifies a register which is a destination of duplication.

TABLE 2-1

| | | |
|---|---|---|
| Function | Opcode | Data |

| | | | |
|---|---|---|---|
| Duplicate | DUP | Dest_Rid | Src_Rid (to be duplicated) |
| | (7′b) | (6′b) | (6′b) |

In the example of Table 2-2, the Src_Rid is “r5” and the Dest_Rid is “r16”. When assembly codes of “DUP r16=r5” are executed, available data of register r5 is duplicated to register r16 without data copy. That is, available data of r5 may be accessed through register r16, without need to copy this data to a new space in the memory storage for r16.

TABLE 2-2

| | | |
|---|---|---|
| Function | Opcode | Data |

| | | | |
|---|---|---|---|
| Duplicate | DUP (7′b) | r16 | r5 |

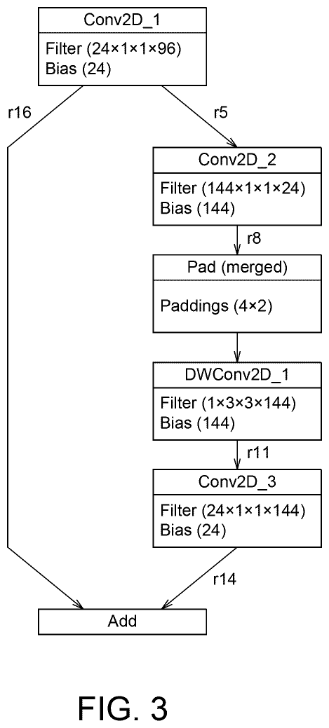

FIG. 3 illustrates a schematic diagram showing split data paths of split connections in a neural network model. The split data paths of FIG. 3 may be executed by one of the computing engines 310 and 320 of FIG. 1. Referring to FIG. 3, at a layer of the neural network model, a two-dimensional (2D) convolutional operation named “Conv2D_1” is performed to generate output data. The output data is stored in the register r5. Then, at a next layer of the neural network model, based on the data in the register r5, another 2D convolutional operation named “Conv2D_2” is performed to generate output data and the output data is stored in register r8. Likewise, at other deeper layers, convolutional operations named “DWConv2D_1” and “Conv2D_3” are performed to generate output data and which are stored in register r11 and r14.

Furthermore, after the operation “Conv2D_1” is performed, the output data is duplicated (by the assembly codes of “DUP r16=r5”) for another data path and stored in register r16, so as to support two split data paths of split connections. Moreover, the data stored in register r16 will be added with the data in register r14. As mentioned before, by executing the assembly codes of “DUP r16=r5”, the output data stored in register r5 is duplicated to register r16 without data copy.

Table 3 shows an example of assembly codes for performing operations of FIG. 3. In Table 3, three “Register_rid” instructions are executed to declare registers r1, r3 and r5 in the memory storage 200, to set required information for these registers r1, r3 and r5. Then, “LOAD” instructions are executed to load data in registers r2 and r4 into registers r1 and r3 respectively. Then, a “CONV” instruction is executed to perform convolutional operation (for example, Conv2D_1) on the data in registers r1 and r3, and a result of convolutional operation is stored in register r5.

TABLE 3

Register_rid mem L1 r1
Register_rid mem L1 r3
Register_rid mem L1 r5
...
LOAD r1 = [r2]
LOAD r3 = [r4]
CONV r5 = r1, r3
Register_rid mem L1 r16
DUP r16 = r5
CONV r8 = r5, r7
DWConv r11 = r8, r10
CONV r14 = r11, r13
ADD r18 = r14, r16

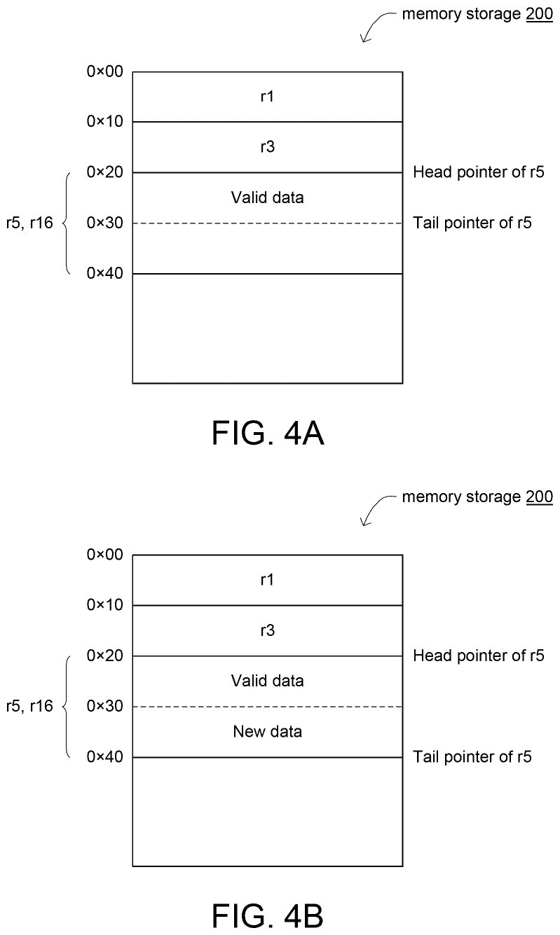

Then, the rest parts of assembly codes in Table 3 are related to another data path of the split connections. A “Register_rid” instruction is executed to declare register r16 in the memory storage 200. As shown in Table 4-1, when “Register_rid” instruction is executed to declare register r16, this new register 16 has the base address “0x20” and bound address “0x40” which are same as register r5. Therefore, as shown in FIG. 4A which illustrates a schematic diagram showing memory allocation of the memory storage 200, the register r16 and register r5 share the same memory space between the base address “0x20” and bound address “0x40” in the memory storage 200.

TABLE 4-1

| | base | bound | delete | head | tail | SEND | RECV | DUP |
|---|---|---|---|---|---|---|---|---|
| Rid | address | address | size | pointer | pointer | busy | busy | Rid |
| 5 | 0x20 | 0x40 | | 0x20 | 0x30 | | 1 | |
| . . . | | | | | | | | |
| 16 | 0x20 | 0x40 | | 0x20 | 0x20 | | | |
| . . . | | | | | | | | |
| N | | | | | | | | |

Then, a “Duplicate” instruction is executed such to duplicate register r5 to register r16. The register r5 has an available data (i.e., valid data) stored between head pointer “0x20” and a tail pointer “0x30”. As shown in Table 4-2, after “Duplicate” instruction is executed, information of head pointer “0x20” and tail pointer “0x30” of register r5 is copied to register r16. The available data between the head pointer “0x20” and the tail pointer “0x30” of register r5 is accessible through register r16. In this manner, register r5 and register r16 can simultaneously use (such as, release or add) the available data in the same memory space of the memory storage 200 without affecting each other.

In addition, register r16 has a parameter of “DUP Rid” indicating the register r5 (i.e., the “DUP Rid” of register r16 may indicate the field “Src_Rid” of the “Duplicate” instruction, to indicate register r5).

TABLE 4-2

| | base | bound | delete | head | tail | SEND | RECV | DUP |
|---|---|---|---|---|---|---|---|---|
| Rid | address | address | size | pointer | pointer | busy | Busy | Rid |
| 5 | 0x20 | 0x40 | | 0x20 | 0x30 | | 1 | |
| . . . | | | | | | | | |
| 16 | 0x20 | 0x40 | | 0x20 | 0x30 | | | 5 |
| . . . | | | | | | | | |
| N | | | | | | | | |

Referring to FIG. 4B, which illustrates another schematic diagram showing memory allocation of the memory storage 200, in which register r5 receives a new data. Then, tail pointer of register r5 is changed to “0x40”, as shown in Table 4-3. Since register r5 has been duplicated to register r16, this new data in register r5 can be accessed through register r16. The tail pointer of register r16 is also changed to “0x40”, which is the same as the tail pointer of register r5.

TABLE 4-3

| | base | bound | delete | head | tail | SEND | RECV | DUP |
|---|---|---|---|---|---|---|---|---|
| Rid | address | address | size | pointer | pointer | busy | busy | Rid |
| 5 | 0x20 | 0x40 | | 0x20 | 0x40 | | 1 | |
| . . . | | | | | | | | |
| 16 | 0x20 | 0x40 | | 0x20 | 0x40 | | | 5 |
| . . . | | | | | | | | |
| N | | | | | | | | |

Till now, registers r1, r3, r5 and r16 have respective memory spaces in the memory storage 200, as shown in Table 4-4. Register r1 has a memory space between base address “0x00” and bound address “0x10”. Furthermore, register r3 has a memory space between base address “0x10” and bound address “0x20”. Moreover, registers r5 and r16 have a same memory space between base address “0x20” and bound address “0x40”.

TABLE 4-4

| | base | bound | delete | head | tail | SEND | RECV | DUP |
|---|---|---|---|---|---|---|---|---|
| Rid | address | address | size | pointer | pointer | busy | busy | Rid |
| 1 | 0x00 | 0x10 | | 0x00 | 0x10 | | | |
| . . . | | | | | | | | |
| 3 | 0x10 | 0x20 | | 0x10 | 0x20 | | | |
| . . . | | | | | | | | |
| 5 | 0x20 | 0x40 | | 0x20 | 0x40 | | | |
| . . . | | | | | | | | |
| 16 | 0x20 | 0x40 | | 0x20 | 0x40 | | | 5 |
| . . . | | | | | | | | |
| N | | | | | | | | |

Thereafter, instructions of “CONV”, “DWConv”, “CONV” and “ADD” are executed. The result of the second “CONV” instruction is stored in register r14, which is added to the data in register r16 by the “ADD” instruction.

Besides, as shown in Table 4-5, register r5 and register r16 may release different amounts of data with their respective delete sizes (according to their respective demands of operations) without affecting each other. For example, register r5 may release data with a delete size of “0x5”, on the other hand, register r16 may release a different amount of data with a delete size of “0x10”. After the delete operation of register r5, the head pointer of r5 becomes 0x25, and after the delete operation of register r16, the head pointer of r16 becomes 0x30.

TABLE 4-5

| | base | bound | delete | head | tail | SEND | RECV | DUP |
|---|---|---|---|---|---|---|---|---|
| Rid | address | address | size | pointer | pointer | busy | busy | Rid |
| 1 | 0x00 | 0x10 | | 0x00 | 0x10 | | | |
| . . . | | | | | | | | |
| 3 | 0x10 | 0x20 | | 0x10 | 0x20 | | | |
| . . . | | | | | | | | |
| 5 | 0x20 | 0x40 | 0x5 | 0x25 | 0x40 | | | |
| . . . | | | | | | | | |
| 16 | 0x20 | 0x40 | 0x10 | 0x30 | 0x40 | | | 5 |
| . . . | | | | | | | | |
| N | | | | | | | | |

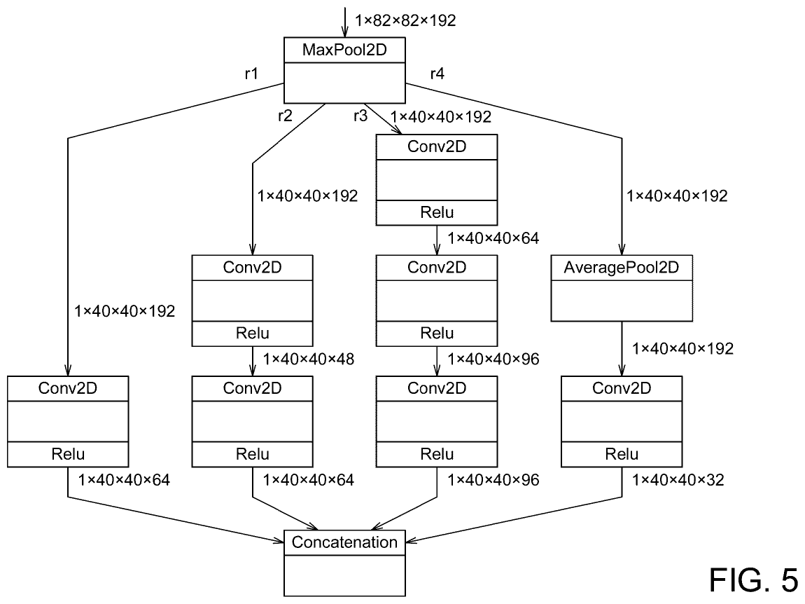

FIG. 5 illustrates a schematic diagram showing a comparative example of split data paths of split connections in the neural network model. Referring to FIG. 5, at a first layer of the neural network model, an operation named “MaxPool2D” is performed, and the operating result is generated. This operating result may be copied as four copies for four data paths respectively. These four copies are stored in registers r1, r2, r3 and r4.

In a first data path, the data in register r1 is provided for a fourth layer to execute a “Conv2D” operation. In a second data path, the data in register r2 is provided for a third layer to execute a “Conv2D” operation. In a third data path, the data in register r3 is provided for a second layer to execute a “Conv2D” operation. In a fourth data path, the data in register r4 is provided for a third layer to execute a “AveragePool2D” operation. Thereafter, a “Concatenation” operation is executed on the operating results of the first, second, third and fourth data paths.

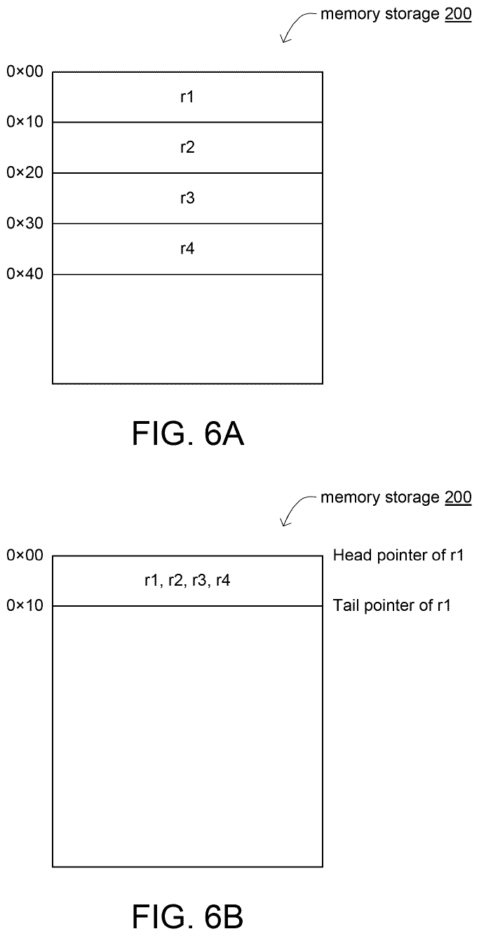

FIG. 6A illustrates a schematic diagram showing memory allocation of the registers r1 to r4 in the memory storage 200, which is for the fourth data paths of FIG. 5. Referring to FIG. 6A, the registers r1 to r4 have different memory spaces respectively, which do not overlap one another. In this comparative example, since four copies of data are stored in different registers r1 to r4, more memory space will be consumed in the memory storage 200. Therefore, the “Duplicate” instruction as the aforementioned example of FIGS. 3, 4A and 4B may be utilized in this example of FIG. 5, so as to save memory space in the memory storage 200.

FIG. 6B illustrates another schematic diagram showing memory allocation of the registers r1 to r4 in the memory storage 200. In the example of FIG. 6B, register r1 is duplicated to registers r2, r3 and r4, as the assembly codes of “DUP r2=r1”, “DUP r3=r1”, and “DUP r4=r1” which are shown in table 5. The registers r1 has an available data, and this data can be accessed by registers r2, r3 and r4. That is, through the “Duplicate” instruction, only one available data stored between head pointer “0x00” and tail pointer “0x10” occupies the memory storage 200, therefore, memory space can be saved. These registers r1 to r4 can simultaneously use this available data in the same memory space between head pointer “0x00” and tail pointer “0x10” without affecting one another.

TABLE 5

DUP r2 = r1
DUP r3 = r1
DUP r4 = r1

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A memory device, for cooperating with at least one computing engine to perform a plurality of neural network computations, the memory device comprising:
a memory storage, configured to store data for the at least one computing engine; and
a memory controller, configured to utilize a plurality of registers to manage a plurality of memory spaces in the memory storage, and execute a first instruction to control at least two data paths in the neural network computations,
wherein the first instruction is utilized to duplicate a first register to a second register, to allow the first register and the second register share one of the memory spaces in the memory storage, wherein the first register and the second register are among the plurality of registers.

2. The memory device of claim 1, wherein the first instruction is a “Duplicate” instruction with a first data field identifying the first register as a source and a second data field identifying the second register as a destination.

3. The memory device of claim 1, wherein each of the plurality of registers has a plurality of parameters including a base address, a bound address, a delete size, a head pointer and a tail pointer, and the base address and the bound address of the first register are the same as the second register.

4. The memory device of claim 3, wherein the one of the memory spaces between the base address and the bound address of the first register is sharable by the second register, and an available data between the head pointer and the tail pointer of the first register is accessible through the second register.

5. The memory device of claim 3, wherein the memory controller is further configured to execute a second instruction to declare the first register and the second register in the memory storage before the first instruction is executed.

6. The memory device of claim 5, wherein the second instruction is a “Register_rid” instruction which sets the base address, the bound address and the delete size of each of the first register and the second register.

7. The memory device of claim 3, wherein each of the plurality of registers further includes an identifier and two indicators, and the memory controller utilizes a managing table to record the base address, the bound address, the delete size, the head pointer, the tail pointer, the identifier and the indicators.

8. The memory device of claim 7, wherein the memory controller comprising:
a compiler, configured to maintain the base address, the bound address and the delete size in a software level.

9. The memory device of claim 8, wherein the memory controller further comprising:
a memory managing unit, configured to control the head pointer, the tail pointer and the indicators in a hardware level.

10. The memory device of claim 1, wherein the memory storage comprises any type of volatile storage or non-volatile storage.

11. A managing method for a memory device, wherein the memory device cooperates with at least one computing engine to perform a plurality of neural network computations, the managing method comprising:
storing data for the at least one computing engine, by a memory storage of the memory device;
utilizing a plurality of registers to manage a plurality of memory spaces in the memory storage, by a memory controller of the memory device; and
executing a first instruction to control at least two data paths in the neural network computations, by the memory controller,
wherein the first instruction is utilized to duplicate a first register to a second register, to allow the first register and the second register share one of the memory spaces in the memory storage, wherein the first register and the second register are among the plurality of registers.

12. The managing method of claim 11, wherein the first instruction is a “Duplicate” instruction with a first data field identifying the first register as a source and a second data field identifying the second register as a destination.

13. The managing method of claim 11, wherein each of the plurality of registers has a plurality of parameters including a base address, a bound address, a delete size, a head pointer and a tail pointer, and the base address and the bound address of the first register are the same as the second register.

14. The managing method of claim 13, wherein the one of the memory spaces between the base address and the bound address of the first register is sharable by the second register, and an available data between the head pointer and the tail pointer of the first register is accessible through the second register.

15. The managing method of claim 13, wherein before the step of executing the first instruction, the managing method further comprising:
executing a second instruction by the memory controller to declare the first register and the second register in the memory storage.

16. The managing method of claim 15, wherein the second instruction is a “Register_rid” instruction which sets the base address, the bound address and the delete size of each of the first register and the second register.

17. The managing method of claim 13, wherein each of the plurality of registers further includes an identifier and two indicators, and the managing method further comprising:
utilizing a managing table by the memory controller, to record the base address, the bound address, the delete size, the head pointer, the tail pointer, the identifier and the indicators.

18. The managing method of claim 17, further comprising:
maintaining the base address, the bound address and the delete size in a software level, by a compiler of the memory controller.

19. The managing method of claim 18, further comprising:
controlling the head pointer, the tail pointer and the indicators in a hardware level, by a memory managing unit of the memory controller.

20. The managing method of claim 11, wherein the memory storage comprises any type of volatile storage or non-volatile storage.
